(19) United States
(12) Patent Application Publication
(10) Pub. No.: US 2026/0346901 A1
(43) Pub. Date: Nov. 5, 2026

(54) STEER-BY-WIRE TRANSLATING HANDWHEEL ACTUATOR WITH REARWARD PIVOT LOCATION

(71) Applicant: Steering Solutions IP Holding Corporation, Saginaw, MI (US)

(72) Inventors: Joen C. Bodtker, Flint, MI (US); Bruce D. Kniebbe, Frankenmuth, MI (US)

(21) Appl. No.: 19/554,235

(22) Filed: Mar. 2, 2026

Related U.S. Application Data
(60) Provisional application No. 63/797,572, filed on Apr. 30, 2025.

(51) Int. Cl. B62D 1/187; B62D 1/04; B62D 1/184; B62D 5/00

(52) U.S. Cl. CPC B62D 1/187; B62D 1/04; B62D 1/184; B62D 5/006

(57) ABSTRACT

A steer-by-wire steering system includes a steering shaft having a first end coupleable to a steering input device. The steering system also includes a column jacket supporting the steering shaft. The steering system further includes a hand wheel actuator operatively associated with the steering shaft to sense steering input and provide feedback. The steering system yet further includes a mounting bracket configured to secure the column jacket to a vehicle structure and to provide a rake pivot axis with the column jacket, wherein the rake pivot axis is located between the first end of the steering shaft and the hand wheel actuator, wherein the hand wheel actuator is completely located between a first end of the mounting bracket and a second end of the mounting bracket.

### CROSS-REFERENCE TO RELATED APPLICATION

This application claims the benefits of priority to U.S. Provisional Patent Application Serial No. 63/797,572, filed Apr. 30, 2025, the disclosure of which is incorporated by reference herein in its entirety.

### FIELD OF THE INVENTION

The disclosure generally relates to vehicle steering systems and, more particularly, to a steer-by-wire translating hand wheel actuator with a rearward pivot location.

### BACKGROUND

Traditional steering column designs have an upper shaft and a lower shaft which connect – via mechanical linkage – a steering wheel and road wheels. In such a configuration, several limitations with respect to collapse performance exist as it relates to functionality and costliness. Steer-by-wire systems eliminate the continuous mechanical connection between the steering wheel and the road wheels by having one or more hand wheel actuators and one or more road wheel actuators utilized to control steering of a vehicle.

During travel of the vehicle, the hand wheel actuator and road wheel actuator cooperate with each other, through electrical communication (e.g., wires, sensors, and a central processing unit), to directionally control travel of the vehicle. More specifically, sensed movement of the respective hand wheel and/or tires is electrically communicated to the respective hand wheel actuator or road wheel actuator to cause movement of the hand wheel and/or tires.

The steer-by-wire systems offer design simplifications and enhancements in some respects, when compared to steering columns requiring a continuous mechanical connection between the steering wheel and the road wheels. For example, the intermediate shaft imposes restrictions due to space claimed under the instrument panel, requiring U-joints to be located under the instrument panel, and the necessity of locating the upper U-joint coincident or nearly coincident with the rake pivot axis. This requires the rake pivot axis to be located at the lower end (i.e., forward in vehicle) of the steering column. This results in large displacement of motion between the column jacket and the instrument panel at the viewing plane of the instrument panel (i.e., rearward in vehicle). The gap is considered unsightly by vehicle interior designers.

### SUMMARY

According to one aspect of the disclosure, a steer-by-wire steering system includes a steering shaft having a first end coupleable to a steering input device. The steering system also includes a column jacket supporting the steering shaft. The steering system further includes a hand wheel actuator operatively associated with the steering shaft to sense steering input and provide feedback. The steering system yet further includes a mounting bracket configured to secure the column jacket to a vehicle structure and to provide a rake pivot axis with the column jacket, wherein the rake pivot axis is located between the first end of the steering shaft and the hand wheel actuator, wherein the hand wheel actuator is completely located between a first end of the mounting bracket and a second end of the mounting bracket.

According to another aspect of the disclosure, a steer-by-wire steering system includes a steering shaft having a first end coupleable to a steering input device. The steering system also includes a fixed-length column jacket supporting the steering shaft. The steering system further includes a hand wheel actuator operatively associated with the steering shaft and including a motor arranged coaxially with the steering shaft. The steering system yet further includes a mounting bracket configured to secure the column jacket to a vehicle structure and to provide a rake pivot axis with the column jacket, wherein the hand wheel actuator is mounted to a side of the column jacket distal from an operator, is disposed between the column jacket and a rake bracket of a rake locking assembly, and is completely located between a first end of the mounting bracket and a second end of the mounting bracket, wherein the mounting bracket provides a linear fore-aft guide along which the steering shaft, the column jacket, and the hand wheel actuator translate together relative to the mounting bracket during axial adjustment, and wherein the rake pivot axis is positioned adjacent to a viewing plane of an instrument panel when installed in a vehicle and is located between the first end of the steering shaft and the hand wheel actuator such that a gap between the column jacket and the instrument panel remains substantially constant throughout an entire range of rake adjustment.

These and other advantages and features will become more apparent from the following description taken in conjunction with the drawings.

### BRIEF DESCRIPTION OF THE DRAWINGS

The subject matter of the present disclosure is particularly pointed out and distinctly claimed in the claims at the conclusion of the specification. The foregoing and other features and advantages of the present disclosure are apparent from the following detailed description taken in conjunction with the accompanying drawings.

FIG. 1 generally illustrates a vehicle steer-by-wire system.

FIG. 2 schematically illustrates a steering column of the system in various rake positions.

FIG. 3 is a side, elevation view of the steering column.

FIG. 4 is a side-elevation view of a portion of the steering column with a portion of the column cut away to expose interior components.

FIG. 5A illustrates rake pivoting aspects of the steering column.

FIG. 5B illustrates axial movement aspects of the steering column.

FIG. 6A illustrates a relative angle between a steering column axis and a mounting bracket during axial movement.

FIG. 6B illustrates parallel axial movement between the steering column axis and the mounting bracket.

### DETAILED DESCRIPTION

Referring now to the figures, where the present disclosure will be described with reference to specific embodiments, without limiting the same, it is to be understood that the disclosed embodiments are merely illustrative of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

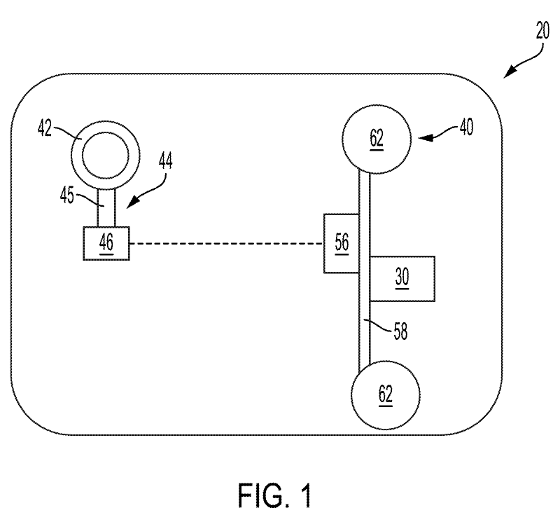

Referring initially to FIG. 1, a vehicle 20 is generally illustrated according to the principles of the present disclosure. The vehicle 20 may be any vehicle, such as a car, a truck, a sport utility vehicle, a mini-van, a crossover, any other passenger vehicle, any commercial vehicle, or any other suitable vehicle. While the vehicle 20 may be a passenger vehicle having wheels and for use on roads, the principles of the present disclosure may apply to other vehicles, such as planes, tractors, boats, or other suitable vehicles. The vehicle 20 may include a propulsion system 30, such as an internal combustion system, an electric system, or combinations thereof.

The vehicle 20 includes a steering system 40. The steering system 40 may be configured as a driver interface steering system, an autonomous driving system, or a system that allows for both driver interface and autonomous steering. The steering system includes a steering input device 42, such as a steering wheel, wherein a driver may manually provide a steering input by turning the steering wheel. A steering column assembly 44 includes a steering column 45 that extends along an axis. A hand wheel actuator (“HWA”) 46 (which may also be referred to as an “emulator”) is provided in the steer-by-wire system and is used to provide feedback and assistance to the steering input device 42 and to receive manual driver inputs for steering control.

The steering column 45 includes one or more portions, which may be referred to as one or more jackets. The jacket(s) are axially and/or height adjustable to be moveable over a range of positions to meet user preferences for positioning of the steering input device 42 and to provide energy absorption benefits during an impact event, as disclosed herein.

A road wheel actuator (“RWA”) 56 is in operative communication with the hand wheel actuator 46. The road wheel actuator 56 actuates lateral maneuvers of the vehicle in response to inputs received from the hand wheel actuator 46. Each of the hand wheel actuator 46 and the road wheel actuator 56 may include a respective processor and controller or a single processor may be in communication with a respective controller of each of the hand wheel actuator 46 and the road wheel actuator 56. The road wheel actuator 56 is part of a system which includes an output that drives a rack, ball screw or any other cross-car oriented component 58 that is operatively coupled to the road wheels 62.

Historically, a continuous mechanical connection spanning multiple components was utilized to connect the steering wheel 42 to the vehicle road wheels 62. However, steer-by-wire systems have eliminated the need for an uninterrupted mechanical connection between the steering wheel 42 and the vehicle road wheels 62. For example, an intermediate shaft is no longer needed in some systems. Advancements such as those outlined above present new opportunities and challenges in steer-by-wire systems.

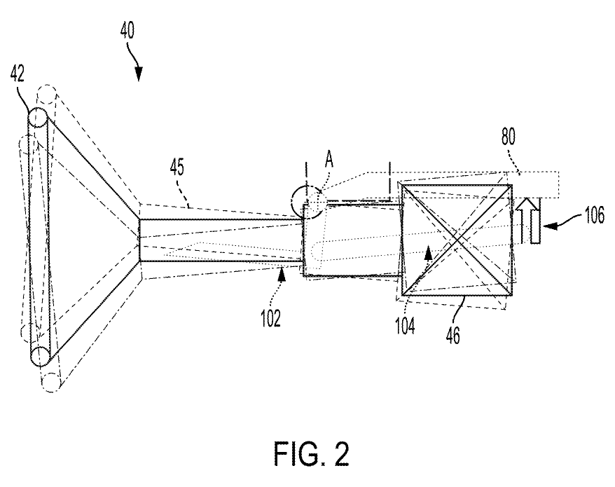

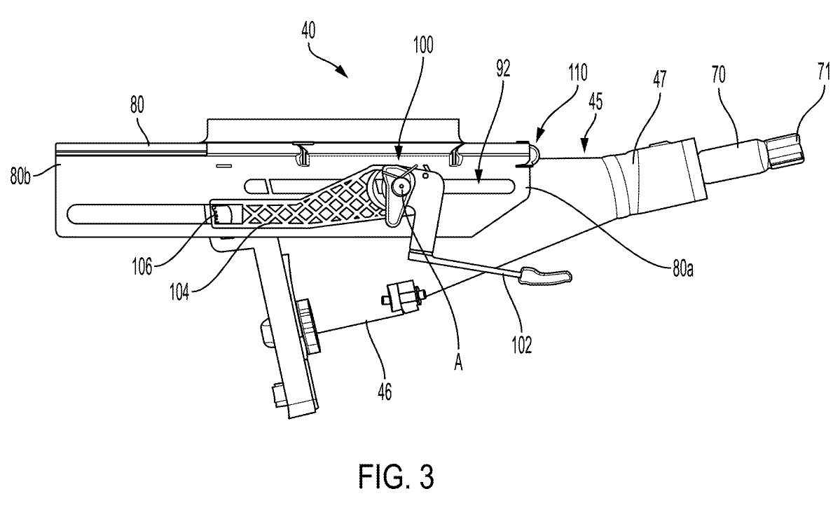

Referring now to FIGS. 2 and 3, the steering system 40 is shown in more detail. The steering input device 42 is operatively coupled to the steering column 45 by connection to a steering shaft 70. The steering shaft 70 has a portion thereof disposed within a jacket 47. The hand wheel actuator 46 is operatively coupled to a side of the jacket 47 distal from an operator. The hand wheel actuator 46 includes a motor disposed within a motor housing. The motor includes an output device or gear assembly which interacts with the steering shaft 70 and is arranged coaxially with the steering shaft 70. The steering wheel 42 is mounted to a first end 71 of the steering shaft 70. The disclosed embodiments eliminate the need for at least some portions of a traditional steering shaft (e.g., intermediate shaft) and facilitates positioning of the hand wheel actuator 46 in close proximity to the steering wheel 42. This allows the overall length of the steering column 45 to be shortened, thereby reducing the overall packaging space required.

The steering column 45 includes a mounting bracket 80 which secures the steering column 45 to a vehicle structure. The steering column 45 includes a rake adjustment mechanism 100 which allows an operator to manually lock and unlock a rake position of the steering column 45. The rake adjustment mechanism 100 includes a rake lever 102 which is rotatable to move the rake adjustment mechanism 100 between a locked condition and an unlocked condition. The rake lever 102 is operatively coupled to a rake release linkage 104 which interacts with a rake locking feature 106 to lock and unlock the rake adjustment mechanism 100. An energy absorption assembly 110 is also provided to assist with impact events.

In some embodiments, the rake adjustment mechanism 100 is implemented as a clamping arrangement that cooperates with the mounting bracket 80 to lock and unlock the steering column 45 in a selected rake position. The clamping arrangement may include the rake lever 102, the rake release linkage 104, and the rake locking feature 106 arranged to apply and release a clamping force at an interface between components carried by the column jacket 47 (for example, a rake bracket) and the mounting bracket 80. When the rake lever 102 is moved to a locked condition, the linkage 104 causes the rake locking feature 106 to generate a clamping force that resists relative motion. When the rake lever 102 is moved to an unlocked condition, the linkage 104 relieves the clamping force to permit rake adjustment.

The clamping arrangement of the rake adjustment mechanism 100 is packaged in close proximity to the mounting bracket 80 so that a load path between the clamping interface and the mounting bracket 80 is short and substantially direct. In one arrangement, at least a portion of the rake lever 102 and the linkage 104 is disposed adjacent an outer surface of the mounting bracket 80, and the rake locking feature 106 is positioned to engage the mounting bracket 80 without a vertically tall stand-off structure. By locating the clamping arrangement close to the mounting bracket 80 rather than spaced vertically away from the mounting bracket 80, an overall vertical package of the steering column assembly 44 is reduced, thereby improving clearance to instrument panel structures, ducts, and other under-panel components. The reduced vertical packaging is further promoted by orienting the rake lever 102 and the linkage 104 so that lever actuation occurs substantially alongside the mounting bracket 80, rather than above or below the mounting bracket 80, while maintaining sufficient mechanical advantage to react expected driver loads and steering wheel abuse loads. In some embodiments, portions of the linkage 104 are routed through openings or recesses defined by the mounting bracket 80 and/or a rake bracket carried by the column jacket 47 to maintain a compact vertical stack-up throughout the full range of rake adjustment.

In some embodiments the mounting bracket 80 defines a rigid frame having a first end 80a and a second end 80b spaced along a vehicle fore-aft direction, which is parallel to a longitudinal direction of the steering system and steering column assembly 44. The frame may be formed as a die cast or stamped metallic structure, such as aluminum or low-carbon steel, with laterally spaced side walls joined by cross members to resist torsional and bending loads. The bracket 80 is configured to be fastened to a vehicle structure, such as a cross-car beam or instrument panel reinforcement, by mechanical fasteners inserted through mounting pads or bosses located on the side walls. The bracket 80 further defines opposed pivot supports that are aligned to establish a rake pivot axis A. Each pivot support may be implemented as a bore, clevis, or spherical socket. Corresponding pivot features on the column jacket 47 are received by the pivot supports so that the column jacket 47, the steering shaft 70, and the hand wheel actuator 46 pivot together as a unit about the rake pivot axis A relative to the mounting bracket 80 when rake adjustment occurs.

The rake pivot axis A is intentionally positioned rearward in the vehicle, when compared to prior systems which pivot about an axis at an end of the steering column (i.e., forward in vehicle) adjacent to or coincident with a viewing plane of an instrument panel when the system is installed. By establishing the pivot near the viewing plane, the exterior surface of the column jacket 47 that interfaces with the instrument panel exhibits substantially no radial sweep relative to the panel during rake motion. As a result, a gap G between the column jacket 47 and the instrument panel remains substantially constant throughout the full rake range. In one embodiment, the axis A is positioned within 5 millimeters of the viewing plane, thereby essentially eliminating visible gap change during rake adjustment.

The mounting bracket 80 also provides a linear fore-aft guide along which the column jacket 47 translates relative to the mounting bracket 80. In one arrangement, the guide includes rails or slide surfaces formed on the inner faces of the bracket side walls, and complementary low-friction sliders, bushings, or recirculating ball elements carried by the column jacket 47. In another arrangement, the bracket 80 defines longitudinal slots 92 and the column jacket 47 carries fasteners riding in the slots via linear bearings, thereby constraining motion along the vehicle fore-aft axis. The linear guide is arranged so that translation of the column jacket 47, the steering shaft 70, and the hand wheel actuator 46 occurs together as a unit, while the bracket 80 remains fixed to the vehicle structure.

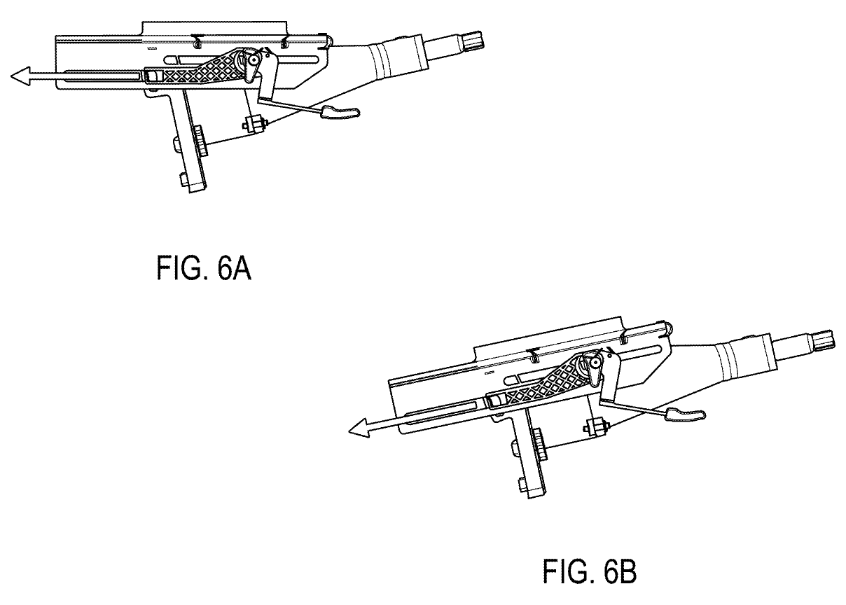

In some embodiments, the linear fore-aft guide provided by the mounting bracket 80 constrains translation of the column jacket 47 along a translation axis T that is intentionally selected to be independent of, and non-collinear with, a centerline axis S of the steering shaft 70. Stated differently, the translation path of the column jacket 47 relative to the mounting bracket 80 may be defined in a vehicle-based direction (for example, substantially horizontal relative to the vehicle floor or substantially parallel to a vehicle fore-aft reference) rather than being constrained to occur strictly along the steering shaft axis S. This arrangement is particularly beneficial where the steering column assembly 44 is installed at a non-zero installation angle relative to the vehicle (for example, a column angle of about 12 degrees as schematically illustrated in FIG. 6A).

By permitting translation along the translation axis T that is independent of the steering shaft axis S, the system reduces or eliminates an inherent overturning moment that would otherwise be induced during reach adjustment when a driver-applied reach load is introduced at the steering input device 42 along a direction that is not aligned with the steering shaft axis S. In conventional arrangements that constrain translation to occur along the steering shaft axis, the installation angle can cause the applied reach load to resolve into components that generate a moment tending to rotate the column jacket 47 relative to the mounting bracket 80 about a lateral axis, thereby increasing friction in the guide interface, increasing bearing side loading, and promoting binding or non-uniform adjustment effort. The disclosed independent translation axis T reduces those moment components and accordingly reduces side loading at the guide interfaces and pivot supports.

In one implementation, the translation axis T is substantially horizontal with respect to the vehicle, while the steering shaft axis S is inclined relative to horizontal, such that translation occurs with a relative angle between the axes S and T (for example, as schematically illustrated in FIG. 6A). In another implementation, the translation axis T is selected to be substantially parallel to the steering shaft axis S (for example, as schematically illustrated in FIG. 6B). In each implementation, the translation axis T may be chosen to optimize adjustment feel, reduce guide wear, and improve controllability of the translation motion while maintaining the packaging relationships described herein, including maintaining the hand wheel actuator 46 completely between the first and second ends 80a, 80b of the mounting bracket 80 during translation.

The hand wheel actuator 46 is mounted on a side of the column jacket 47 distal from the first end 71 of the steering shaft 70. The actuator 46 includes a motor disposed within a motor housing 46a, and the motor output is arranged coaxially with the steering shaft 70. A torque transfer element, such as a torsionally rigid coupling, spline, or gear set, connects the motor output to the steering shaft 70 to generate feedback and to sense driver input torque or angle. The coaxial arrangement reduces package length and supports compact packaging between the bracket ends 80a, 80b. The actuator 46 is fastened to mounting bosses on the column jacket 47 using vibration-isolating bushings to mitigate noise and harshness while maintaining positional accuracy for angle and torque sensing.

In certain configurations, the hand wheel actuator 46 is positioned axially between the pivot features and the steering input device 42, yet completely within the span defined by the first and second ends 80a, 80b of the mounting bracket 80. This arrangement yields multiple advantages. First, a shorter overall column length is achieved, easing packaging constraints near the instrument panel. Second, by locating the mass of the actuator 46 between the bracket ends, the inertial loads induced during vehicle crash events are reacted directly into the bracket 80, improving robustness of the energy absorption assembly 110. Third, by keeping the actuator 46 between the bracket ends, cable routing and electrical connector access can be managed without increasing the gap to the instrument panel.

The rake locking assembly 100 includes a rake bracket 120 that is carried by, and moves with, the column jacket 47 about the rake pivot axis A. The rake bracket 120 is configured to interface with the mounting bracket 80 to lock the column in a selected rake position. The linkage 104 is operatively coupled between the rake lever 102 and the rake locking feature 106 on the rake bracket 120. In one embodiment, the rake locking feature 106 comprises a toothed sector on the rake bracket 120 that engages a pawl supported on the mounting bracket 80. Rotation of the rake lever 102 moves the linkage 104 to rotate the pawl between an engaged state, preventing relative rotation, and a disengaged state, permitting rake adjustment. In another embodiment, the rake locking feature 106 is a friction clamp that biases a high-friction interface between the rake bracket 120 and the mounting bracket 80. In each case, the geometry and moment arm of the linkage 104 are selected so that driver actuation effort remains within ergonomic limits while reacting the expected steering wheel abuse loads and system loads. Because the actuator 46 is located between the column jacket 47 and the rake bracket 120, the mass and torque reactions of the actuator are carried within the locked subassembly and do not introduce additional bending in the bracket 80 beyond design allowances.

In the illustrated embodiments, the column jacket 47 may be a fixed-length structure, such as a drawn-over-mandrel tube or hydroformed section with integrated mounting features. When a fixed-length jacket is employed, fore-aft position is provided exclusively by the translation of the jacket 47 along the guide, thereby eliminating telescoping interfaces and their associated rattle risk. The steering shaft 70 may be a unitary or splined shaft supported by bearings within the jacket 47. Radial bearings may be angular-contact or deep-groove ball bearings retained within the jacket by snap rings or threaded retainers, with axial preload controlled to maintain low lash for haptic fidelity from the hand wheel actuator 46.

To ensure a substantially constant gap G during rake, the external surface geometry of the column jacket 47 proximate to the instrument panel is contoured to follow a surface of revolution about the rake pivot axis A. The contour may be defined as a cylindrical or conical surface segment centered on axis A such that any rotation about A causes minimal relative displacement normal to the instrument panel viewing plane. In some implementations, a flexible shroud or boot is attached to the instrument panel and lightly contacts the contoured surface of the jacket 47 to maintain an aesthetically continuous interface while permitting both rake and translation motions.

The assembly process may proceed as follows. The pivot features of the column jacket 47 are aligned with the pivot supports of the mounting bracket 80 and retained by fasteners, pins, or interference-fit bushings that establish the rake pivot axis A. The hand wheel actuator 46 is coupled to the steering shaft 70 and secured to the jacket 47. The rake bracket 120 is attached to the jacket 47 on the operator-proximal side, with the actuator 46 disposed between the jacket wall and the rake bracket 120. The linkage 104 is connected to the rake lever 102 and the rake locking feature 106. The linear guide elements are assembled so that the column subassembly is captured for fore-aft motion relative to the mounting bracket 80. The mounting bracket 80 is then secured to the vehicle structure so that axis A is located adjacent to the instrument panel viewing plane, as defined by vehicle interior design.

During operation, with the rake lever 102 in the unlocked position, the driver may pivot the steering column about the rake pivot axis A through the available rake range and also translate the steering column fore-aft along the linear guide to set reach. With the lever 102 in the locked position, the rake bracket 120 and the mounting bracket 80 are fixed against relative motion, and any forces generated by the driver at the steering input device 42 are reacted through the locked interface to the vehicle structure. The hand wheel actuator 46 senses driver-applied torque and/or steering wheel angular position through the coaxial motor and associated sensors and delivers haptic feedback to emulate road feel, while also communicating with the road wheel actuator 56 for steer-by-wire control.

The travel limiter assembly referenced above may be implemented as a pair of arcuate stops disposed within the jacket 47 that engage a stop feature keyed to the steering shaft 70, limiting angular rotation to a safe range appropriate for a steer-by-wire hand wheel, for example ±540 degrees from center. A sensor assembly may include a multi-turn absolute encoder or resolver coupled to the steering shaft 70, and a torque sensor integrated with the motor shaft or a torsion bar element. The sensor signals may be routed through a harness that is secured to the column jacket 47 and bracket 80 such that the harness flexes minimally during rake and translation.

Materials and tolerances are selected to withstand the design loading conditions and to maintain alignment under temperature and vibration. The mounting bracket 80 may be fabricated from aluminum alloy with a yield strength of 150 to 250 MPa, the column jacket 47 from steel or aluminum tubing with wall thickness between 1.5 and 3.5 millimeters, and the pivot bushings from sintered bronze or polymer composites for low friction and wear resistance. The rails or slides of the linear guide may include low-friction coatings such as PTFE-impregnated layers or hard anodizing when aluminum is used.

Alternative embodiments contemplate different implementations of the pivot and guide without departing from the functional relationships described. For example, the pivot supports may be realized as trunnions extending from the jacket 47 into bearings housed by the bracket 80, or as an axle fixed to the bracket 80 passing through bearings carried by the jacket 47. The linear guide may employ dual parallel rails for improved stiffness, a central dovetail slide, or a pair of cylindrical shafts and linear bushings. In all cases, the guide constrains motion to the fore-aft axis and supports the combined mass of the steering shaft 70, the column jacket 47, and the hand wheel actuator 46 during translation.

Various packaging relationships are contemplated so long as the hand wheel actuator 46 remains completely between the first end 80a and the second end 80b of the mounting bracket 80 and is located between the column jacket 47 and the rake bracket 120. For example, the actuator 46 may be partially nested within a recess formed in the column jacket 47 on the distal side to further reduce protrusion toward the operator. Additionally, the actuator 46 may be clocked circumferentially around the steering shaft 70 to clear vehicle components while maintaining the required positional relationship with the bracket ends and the rake bracket.

In some embodiments, the rake locking assembly 100 is power assisted. A compact electric or pneumatic actuator may drive the linkage 104 to move the locking feature 106 between locked and unlocked conditions under electronic control, for example in response to a driver profile selection. Regardless of manual or powered locking, the geometry of the locking interface is configured to react both the static and dynamic loads encountered during normal operation and misuse cases, and to maintain the position of the column relative to the mounting bracket 80 without creep.

The disclosed configurations enable the steering shaft 70, the column jacket 47, and the hand wheel actuator 46 to pivot together about the rake pivot axis A and to translate together along the linear guide, while preserving the aesthetic and functional interface to the instrument panel. By eliminating telescoping jacket sections and placing the rake pivot adjacent the instrument panel viewing plane, the system maintains a substantially constant gap G during rake and reach adjustments, reduces component count, and supports robust steer-by-wire driver interface performance.

While illustrated relative positions may indicate the axis A located between the first end of the steering shaft 70 and the hand wheel actuator 46, it is contemplated that the exact axial spacing may be varied to suit differing instrument panel depths while still maintaining the axis A rearward relative to the hand wheel actuator 46 and adjacent to the instrument panel viewing plane so that the constant-gap behavior is achieved. Moreover, the magnitude of the available fore-aft translation and rake angle may be tuned independently of each other and of the positional relationship of the actuator 46 to the bracket ends 80a, 80b by modifying the linear guide stroke length and the arc of engagement of the rake locking feature 106.

It will be appreciated that the structural features described herein may be applied to steer-by-wire columns employing alternative hand wheel input devices, such as yokes, and that the term “distal from an operator” denotes the side of the column jacket 47 away from the driver-side occupant compartment. The described mounting bracket 80, pivot supports, and linear guide cooperate to maintain the defined positional constraints of the hand wheel actuator 46 and to achieve the constant-gap interface with the instrument panel throughout the range of adjustment.

The foregoing embodiments provide sufficient detail for implementation by one of ordinary skill in the art, including the arrangement wherein the mounting bracket 80 provides the fore-aft linear guide, the column jacket 47 is of fixed length, the hand wheel actuator 46 is coaxial with and operatively associated with the steering shaft 70, the actuator 46 is mounted to the distal side of the column jacket 47 and disposed between the jacket 47 and the rake bracket 120, the actuator 46 is completely located between the bracket ends 80a, 80b, the rake pivot axis A is located between the first end of the steering shaft 70 and the actuator 46 and is positioned adjacent to the instrument panel viewing plane, and the steering shaft 70, the column jacket 47, and the actuator 46 translate together during axial adjustment and pivot together during rake adjustment while maintaining a substantially constant gap to the instrument panel.

With the intermediate shaft no longer part of the steering system, and with the features of the embodiments disclosed herein, the pivot location of the steering column can be placed at or adjacent to the viewing plane of the instrument panel, and/or at or near the top of the steering column jacket 47 to minimize gap variation to the instrument panel. Advantageously, the gap between the column jacket and the instrument panel is minimized or eliminated to remove visual discontinuity of the column interface. The gap width is fixed and can easily be covered. The adjustment mechanism for manual columns will have more favorable leverage with the steering wheel for adjustment increment size and reacted locking loads. The length of the steering column can be more easily increased forward in vehicle toward the compartment separator to enable longer jackets which will support high travel stowable column design.

The embodiments disclosed herein allow the end of the column to be free to translate fore-aft without impacting steering kinematics. The jacket assembly can translate with respect to the mounting bracket. Advantageously, two telescoping jackets can be combined into one translating part, the telescoping steering shaft can be reduced to one fixed shaft, and/or the jacket, shaft and motor can be consolidated into one assembly.

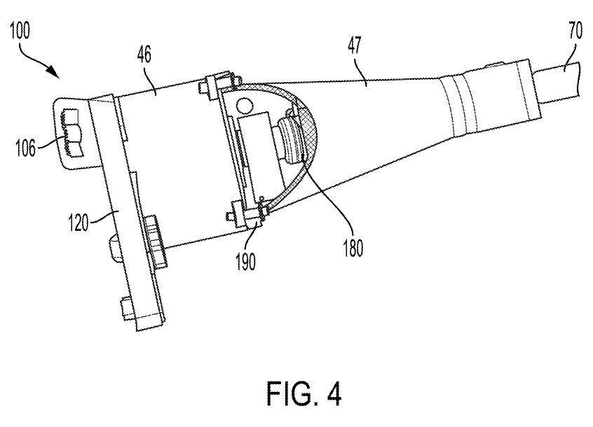

FIG. 4 is a partial side-elevation view of the steering column showing internal components. A travel limiter assembly is disposed within the column jacket and is operatively coupled to the steering shaft to constrain rotational motion to a predefined range. The travel limiter assembly includes a stop feature keyed to the steering shaft and cooperating arcuate stops retained within the jacket such that engagement of the stop feature with the arcuate stops arrests rotation at the limits of travel. A sensor assembly is also shown and includes an angular position sensor configured to detect steering shaft position and a torque sensor configured to detect driver-applied input, the sensor assembly being mounted proximate to the upper bearing inside the jacket and electrically coupled to the hand wheel actuator.

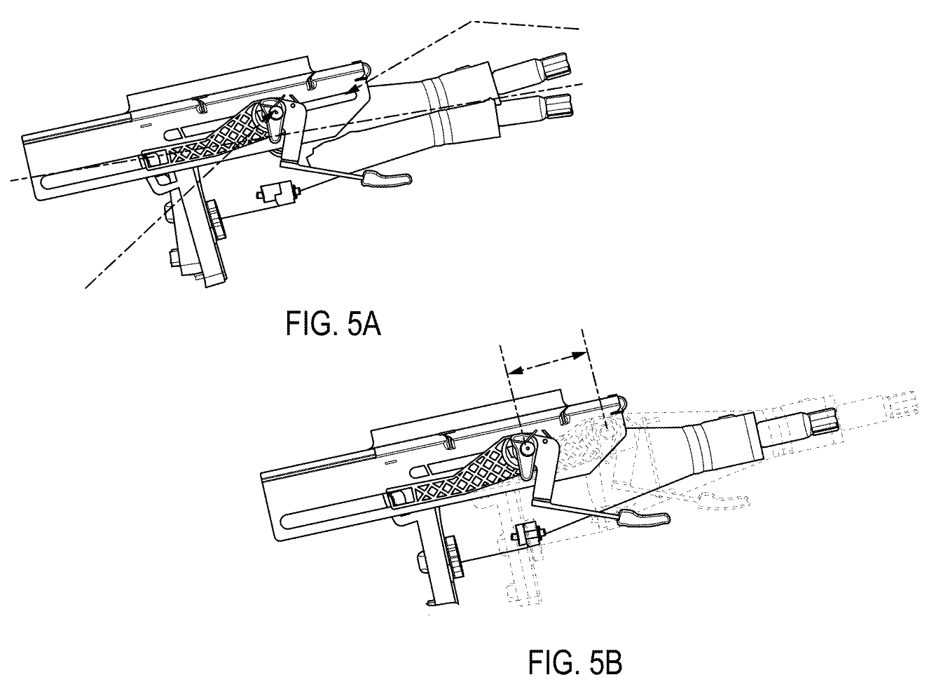

FIG. 5A is a schematic side view of the steering column and mounting bracket illustrating the rake pivot and the fore-aft translation slots. Opposed pivot supports of the mounting bracket define the rake pivot axis, and corresponding pivot features of the column jacket are received by the pivot supports so that the steering shaft, column jacket, and hand wheel actuator pivot together about the rake pivot axis. Longitudinal slots formed in the mounting bracket provide a linear guide for telescope travel of the column jacket relative to the mounting bracket. A nominal rake column centerline is indicated to show the geometric relationship of the jacket surface to the instrument panel viewing plane.

FIG. 5B is a schematic side view similar to FIG. 5A showing telescope (translating) motion. Sliders or bearings carried by the column jacket ride within the longitudinal slots of the mounting bracket so that the steering shaft, column jacket, and hand wheel actuator translate fore-aft together as a unit while the mounting bracket remains fixed to the vehicle structure. The arrangement maintains the hand wheel actuator completely between the first and second ends of the mounting bracket during translation.

FIG. 6A is a schematic side view illustrating horizontal telescope and collapse with a 12° column angle. The fore-aft translation path is shown as substantially horizontal relative to the vehicle, and the steering column axis is oriented at a 12° relative angle. During a collapse event, energy absorption components react loads while the column subassembly translates along the horizontal guide, preserving the constant-gap interface at the instrument panel.

FIG. 6B is a schematic side view illustrating parallel telescope and collapse at a 0° relative angle. The telescope motion is on-axis with the steering column centerline, and collapse occurs along the same axis while the steering shaft, column jacket, and hand wheel actuator remain kinematically constrained to move together. In both FIGS. 6A and 6B, the rake pivot axis is positioned adjacent to the instrument panel viewing plane, thereby maintaining a substantially constant gap between the column jacket and the instrument panel throughout the available rake range.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in scope with the present disclosure. Additionally, while various embodiments of the present disclosure have been described, it is to be understood that aspects of the present disclosure may include only some of the described embodiments or combinations of the various embodiments. Accordingly, the present disclosure is not to be seen as limited by the foregoing description.

What is claimed is:

1. A steer-by-wire steering system comprising:
a steering shaft having a first end coupleable to a steering input device;
a column jacket supporting the steering shaft;
a hand wheel actuator operatively associated with the steering shaft to sense steering input and provide feedback; and
a mounting bracket configured to secure the column jacket to a vehicle structure and to provide a rake pivot axis with the column jacket, wherein the rake pivot axis is located between the first end of the steering shaft and the hand wheel actuator, wherein the hand wheel actuator is completely located between a first end of the mounting bracket and a second end of the mounting bracket.

2. The steer-by-wire steering system of claim 1, further comprising a rake locking assembly having a rake bracket.

3. The steer-by-wire steering system of claim 2, wherein the hand wheel actuator is located between the column jacket and the rake bracket.

4. The steer-by-wire steering system of claim 1, wherein the column jacket is configured to translate fore-aft relative to the mounting bracket.

5. The steer-by-wire steering system of claim 1, wherein the hand wheel actuator includes a motor arranged coaxially with the steering shaft.

6. The steer-by-wire steering system of claim 1, wherein the hand wheel actuator is mounted to a side of the column jacket distal from the first end of the steering shaft.

7. The steer-by-wire steering system of claim 1, wherein the rake pivot axis is positioned adjacent to a viewing plane of an instrument panel when installed in a vehicle.

8. The steer-by-wire steering system of claim 1, wherein a gap between the column jacket and an instrument panel remains substantially constant during an entire range of rake adjustment.

9. The steer-by-wire steering system of claim 2, wherein the rake locking assembly further comprises a linkage operatively coupled to a manual adjustment lever and the rake bracket to selectively move the rake locking assembly between a locked condition and an unlocked condition.

10. The steer-by-wire steering system of claim 1, wherein the steering shaft, the column jacket, and the hand wheel actuator translate together, relative to the mounting bracket, during axial adjustment.

11. The steer-by-wire steering system of claim 1, wherein the steering shaft, the column jacket, and the hand wheel actuator pivot about the rake pivot axis together, relative to the mounting bracket, during rake adjustment.

12. A steer-by-wire steering system comprising:
a steering shaft having a first end coupleable to a steering input device;
a fixed-length column jacket supporting the steering shaft;
a hand wheel actuator operatively associated with the steering shaft and including a motor arranged coaxially with the steering shaft; and
a mounting bracket configured to secure the column jacket to a vehicle structure and to provide a rake pivot axis with the column jacket, wherein the hand wheel actuator is mounted to a side of the column jacket distal from an operator, is disposed between the column jacket and a rake bracket of a rake locking assembly, and is completely located between a first end of the mounting bracket and a second end of the mounting bracket, wherein the mounting bracket provides a linear fore-aft guide along which the steering shaft, the column jacket, and the hand wheel actuator translate together relative to the mounting bracket during axial adjustment, and wherein the rake pivot axis is positioned adjacent to a viewing plane of an instrument panel when installed in a vehicle and is located between the first end of the steering shaft and the hand wheel actuator such that a gap between the column jacket and the instrument panel remains substantially constant throughout an entire range of rake adjustment.

13. The steer-by-wire steering system of claim 12, further comprising a rake locking assembly having a rake bracket.

14. The steer-by-wire steering system of claim 13, wherein the hand wheel actuator is located between the column jacket and the rake bracket.

15. The steer-by-wire steering system of claim 13, wherein the rake locking assembly further comprises a linkage operatively coupled to a manual adjustment lever and the rake bracket to selectively move the rake locking assembly between a locked condition and an unlocked condition.

16. The steer-by-wire steering system of claim 13, wherein the mounting bracket includes opposed pivot supports defining the rake pivot axis and receiving corresponding pivot features of the column jacket.

17. The steer-by-wire steering system of claim 13, wherein during rake adjustment the steering shaft, the column jacket, and the hand wheel actuator pivot together as a unit about the rake pivot axis relative to the mounting bracket.
